(19) United States
(12) Patent Application Publication
(10) Pub. No.: US 2026/0276817 A1
(43) Pub. Date: Sep. 17, 2026

(54) LiDAR APPARATUS AND DRIVING METHOD THEREOF

(71) Applicant: LX SEMICON CO., LTD., Daejeon (KR)

(72) Inventors: Sangjin Lee, Daejeon (KR); Seonghong Park, Daejeon (KR); Minsu Kim, Daejeon (KR)

(73) Assignee: LX SEMICON CO., LTD., Daejeon (KR)

(21) Appl. No.: 19/565,338

(22) Filed: Mar. 12, 2026

(30) Foreign Application Priority Data
Mar. 12, 2025 (KR) 10-2025-0032367
Mar. 11, 2026 (KR) 10-2026-0043688

(51) Int. Cl. G01S 17/10; G01S 7/486; G01S 7/4863; G01S 7/4865; G01S 7/487

(52) U.S. Cl. CPC G01S 17/10; G01S 7/4863; G01S 7/4866; G01S 7/4868; G01S 7/4873; G01S 7/4876

(57) ABSTRACT

A LiDAR apparatus and a method of operating the same are disclosed. A SPAD (Single Photon Avalanche Diode)-based LiDAR apparatus according to at least one of various embodiments of the present disclosure may include a light emitting unit configured to transmit a laser pulse; a sensor array configured to receive reflected light reflected from an object by the laser pulse; a histogram generator configured to generate a histogram based on the reflected light; a histogram quality analyzer configured to analyze a change in a shape of the histogram and determine a storage time point before histogram distortion occurs; a storage timing controller configured to control storing of a histogram corresponding to the storage time point during histogram accumulation; and a distance calculator configured to calculate distance information using the stored histogram.

### TECHNICAL FIELD

The present disclosure relates to a distance measurement technology, and more particularly, to a SPAD (Single Photon Avalanche Diode)-based LiDAR (Light Detection And Ranging) apparatus and a method of operating the same.

### BACKGROUND ART

A Single Photon Avalanche Diode (SPAD)-based Light Detection And Ranging (LiDAR) system calculates distance information by using a time difference (Time of Flight, ToF) between a transmitted laser pulse and an arrival time of reflected light, and generally generates a time-axis histogram by performing a plurality of transmission/reception repetitions during one frame. Thereafter, a distance is calculated by detecting a peak position from the histogram at a time point at which the frame ends.

However, when a short-distance object or a high-reflectance object exists, saturation occurs because counts are excessively concentrated in a specific bin during a histogram accumulation process, and when a plurality of adjacent objects exist, there is a problem in that widths of histogram peaks abnormally increase because different reflected signals temporally overlap each other. In such a case, it is difficult to accurately calculate actual distance information only with a final histogram remaining at the time point at which the frame ends.

Conventionally, in order to solve such a problem, a method of performing a plurality of measurements having different exposure conditions, or a method of separating exposure times and then combining results thereof, has been proposed.

However, such a conventional method causes problems such as a change in a frame structure, complication of measurement timing, an increase in emission power, and vulnerability in a moving object environment, and in particular, has a limitation in that a separate physical memory expansion or an additional control logic is required, thereby increasing system complexity and chip area.

### DISCLOSURE

### Technical Problem

One problem of the present disclosure is to improve reliability and a dynamic range of distance information by adaptively controlling an exposure condition and a sampling condition in a histogram-based distance measurement in a SPAD-based LiDAR system.

Another problem of the present disclosure is to provide a method for selectively securing a histogram already including valid distance information during a histogram accumulation process without changing an exposure time or a transmission count.

Still another problem of the present disclosure is to improve reliability and a dynamic range of distance measurement by detecting, by using not a count size itself of a histogram but a change in a shape of the histogram, particularly a change in a peak width, a time point before distortion occurs, and storing and using a histogram at the corresponding time point.

Still another problem of the present disclosure is to improve a dynamic range of distance measurement by selectively storing, during a process of accumulating and generating a histogram during one measurement frame, a histogram corresponding to a time point before distortion occurs by analyzing a shape change of the histogram.

Technical problems according to the present disclosure are not limited to those described in this section, and include those that may be grasped through the following description of the invention.

### Technical Solution

A Single Photon Avalanche Diode (SPAD)-based Light Detection And Ranging (LiDAR) apparatus according to at least one of various embodiments of the present disclosure may include: a light emitting unit configured to transmit a laser pulse; a sensor array configured to receive reflected light reflected from an object by the laser pulse; a histogram generator configured to generate a histogram based on the reflected light; a histogram quality analyzer configured to analyze a change in a shape of the histogram and determine a storage time point before histogram distortion occurs; a storage timing controller configured to control storing of a histogram corresponding to the storage time point during histogram accumulation; and a distance calculator configured to calculate distance information using the stored histogram.

At this time, the histogram quality analyzer may be configured to calculate an index related to a width of a histogram peak and determine the storage time point based on whether the index related to the width exceeds a reference value, and the change in the shape of the histogram is analyzed based on a change in the index calculated based on the width of the histogram peak.

In addition, the index related to the width may be a full width at half maximum (FWHM) of the histogram peak, and wherein the histogram quality analyzer is configured to calculate a histogram quality index (WER) based on a ratio of the FWHM to a reference FWHM.

Also, the storage timing controller may be configured to determine the storage time point as a time point at which the histogram quality index reaches or exceeds a predetermined reference value or a time point immediately before the time point.

In addition, the histogram generator may be configured to store the histogram corresponding to the storage time point in parallel while continuously performing histogram accumulation until a frame end time point.

Also, the histogram quality analyzer may be configured to detect whether a width of a histogram peak expands due to histogram saturation and/or overlap caused by a short-distance object or a plurality of objects.

In addition, the histogram generator or the distance calculator may be configured to detect a peak after performing filtering on the stored histogram.

Also, the histogram generator may include a plurality of histogram memories configured to store histograms corresponding to different accumulation time points.

In addition, the plurality of histogram memories may be configured to store histograms corresponding to different storage time points within the same frame.

Also, determination of the storage time point may be performed based on the change in the shape of the histogram irrespective of a change in an exposure time, a transmission count, a sampling width, or a filter coefficient.

In addition, the distance calculator may be configured to calculate the distance information by preferentially using the histogram stored at the storage time point rather than a histogram at a frame end time point.

Also, the storage time point may be determined by applying a common storage time point determination criterion to one frame in a frame unit driving mode.

In addition, the storage time point is determined for each of a plurality of pixel groups in a pixel group unit driving mode.

Also, the storage timing controller may be configured to set different storage time points and/or different histogram storage policies for respective pixel groups.

Meanwhile, the sampling width may be configured to be variably set according to histogram quality or an environmental condition.

A driving method of a SPAD-based LiDAR apparatus according to at least one of various embodiments of the present disclosure may include: transmitting a laser pulse; receiving reflected light reflected from an object by the laser pulse; generating a histogram based on the reflected light; analyzing a change in a shape of the histogram to determine a storage time point before histogram distortion occurs; storing a histogram corresponding to the storage time point during histogram accumulation; and calculating distance information using the stored histogram.

### Advantageous Effects

According to a SPAD-based LiDAR apparatus and a driving method thereof according to at least one of various embodiments of the present disclosure, there are the following effects.

First, there is an advantage that reliability of distance measurement can be improved even in an environment in which a short-distance high-reflectance object or a plurality of objects exist.

Second, there is an advantage that timing complication due to frame division or a plurality of exposure operations and a distance mismatch problem in a moving object environment can be effectively avoided.

Third, there is an advantage that, since an already provided histogram memory or a plurality of storage regions are utilized without a separate large-scale memory expansion, an effective dynamic range of histogram-based distance measurement can be expanded while suppressing increases in system complexity and chip area.

Fourth, there is an advantage of being flexibly applicable to various driving methods and system configurations.

### DESCRIPTION OF DRAWINGS

FIG. 1 is an overall configuration block diagram of a SPAD-based LiDAR system.

FIG. 2 is a timing diagram for explaining laser transmission, light reception, and histogram generation operations in the LiDAR system.

FIG. 3 is a view illustrating an example of a histogram generated by a single reflector under an ideal condition.

FIG. 4 is a view for explaining a phenomenon in which distance distortion occurs due to histogram overlap when a plurality of reflectors exist.

FIG. 5 is a view illustrating an example in which histogram overlap is intensified according to time accumulation.

FIG. 6 is a view conceptually explaining a principle of occurrence of a distance error according to a shape change of a histogram.

FIG. 7 is a view comparing and illustrating a conceptual difference between Long and Short exposure methods and an adaptive exposure method.

FIG. 8 is a block diagram illustrating an embodiment of a histogram generation and storage structure.

FIG. 9 is a view illustrating an example of filtering processing for a histogram signal.

FIG. 10 is a view comparing and illustrating a difference in quality of histograms generated under different environmental conditions.

FIG. 11 is a view illustrating an operation flow in a frame unit control mode.

FIG. 12 is a view illustrating an operation flow in a pixel group unit control mode.

FIG. 13 is a view schematically illustrating, in a SPAD-based LiDAR system, what temporal and hierarchical structure measurement operations performed within one frame have when operating in the frame unit control mode.

FIG. 14 is a view illustrating, in a pixel group unit control mode, a temporal arrangement structure of pre-inspection and main scan operations performed for each pixel group within one frame.

FIG. 15 is a conceptual diagram illustrating an overall distance measurement processing flow.

### DETAILED DESCRIPTION FOR CARRYING OUT THE INVENTION

Hereinafter, embodiments for solving the above problems will be described in more detail with reference to the drawings.

Suffixes “module” and “unit” for components used in the following description are assigned only in consideration of ease of writing this specification, and do not themselves impart particularly important meanings or roles. Accordingly, the “module” and the “unit” may be used interchangeably with each other.

Terms including ordinals such as first and second may be used to describe various components, but the components are not limited by the terms. The terms are used only for the purpose of distinguishing one component from another component.

Singular expressions include plural expressions unless the context clearly indicates otherwise.

In the present application, terms such as “include,” “have,” or “are provided with” should be understood as intending to designate the presence of stated features, numbers, steps, operations, components, parts, or combinations thereof described in the specification, and not as precluding in advance the presence or possibility of addition of one or more other features, numbers, steps, operations, components, parts, or combinations thereof.

Hereinafter, according to at least one of various embodiments of the present disclosure, a distance measurement apparatus, particularly, for convenience of explanation, a Single Photon Avalanche Diode (SPAD)-based Light Detection And Ranging (LiDAR) apparatus and a method of operating the same will be described in detail. The embodiments described in the present specification are provided for explaining the technical spirit of the present disclosure, and the scope of the present disclosure is not limited thereto.

Hereinafter, in this specification, a “single measurement cycle” or a “single frame” means a measurement unit including a histogram generated as a result of the LiDAR apparatus repeatedly performing transmission and reception operations for a predetermined time in order to calculate one distance measurement result. During such a single frame, a plurality of transmission pulses may be emitted, and reflected signals corresponding thereto may be received, so that a time-axis histogram may be accumulated and generated.

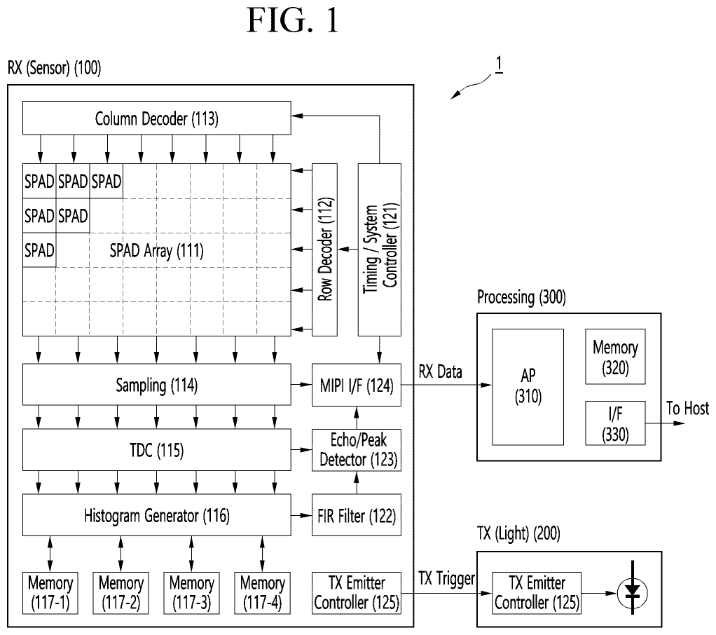

FIG. 1 is a view illustrating a configuration diagram of a LiDAR system 1.

FIG. 1 is, in particular, a schematic block diagram illustrating an overall configuration of the SPAD-based LiDAR system 1.

The configuration illustrated in FIG. 1 represents a basic hardware configuration that may be generally used in the SPAD-based LiDAR system 1. However, in the present disclosure, there is a difference from the related art in a generation and storage method of a histogram and a control method thereof.

Referring to FIG. 1, the LiDAR system 1 includes a light emitting unit TX 200 transmitting a laser pulse, a light receiving unit RX 100 receiving reflected light, and a processor 300 processing a received signal to calculate distance information and output the distance information to the outside. Here, each component may be integrated into one chip, or may be implemented as a plurality of chips or modules separately. Meanwhile, FIG. 1 corresponds to a conceptual diagram for explaining a functional configuration rather than limiting such an implementation form.

The light receiving unit RX 100 is a configuration for detecting photons reflected and incident from an object and generating time information corresponding thereto.

Referring to FIG. 1, the light receiving unit RX 100 may include a sensor array 111, a row decoder 112, a column decoder 113, a sampling circuit 114, a time-to-digital Converter (TDC) 115, a histogram generator 116, a plurality of histogram memories 117-1 to 117-4, a Finite Impulse Response (FIR) filter 122, an Echo/Peak Detector 123, and a Mobile Industry Processor Interface (MIPI) interface 124. The SPAD array 111 detects incident photons, and output signals of pixels selected by the row decoder 112 and the column decoder 113 may be sampled through the sampling circuit 114. The sampled signals are converted into time information by the TDC 115, and may be accumulated as histograms for respective time sections by the histogram generator 116. The histograms may be stored in the plurality of histogram memories 117-1 to 117-4, and may be transmitted to an external device through the MIPI interface 124 after being processed through the FIR filter 122 and the Echo/Peak Detector 123. At this time, among components illustrated as one component of the light receiving unit RX 100 in FIG. 1, some of the components (for example, the Histogram Generator, the histogram memories, and the like) may be disposed outside the light receiving unit RX 100, and may also be formed as independent entities. Meanwhile, since the present disclosure relates to the SPAD-based LiDAR system 1, hereinafter, in this specification, for convenience of description, the sensor array 111 will be referred to as the SPAD array 111.

The SPAD array 111 includes a plurality of SPAD pixels, and detects photons reflected and incident from an object to generate photon detection events. The photon detection events are represented as electrical event signals generated by an avalanche operation of the SPAD. Events occurring in respective SPAD pixels are selectively read together with position information of corresponding SPAD pixels through the row decoder 112 and the column decoder 113, and the sampling circuit 114 samples the electrical event signals according to predetermined sampling timing. In this specification, a “photon event” or a “photon detection event” means a detection event generated when a photon incident on a SPAD pixel causes an avalanche operation of the SPAD. The photon events are output in a form of electrical event signals, and the event signals are recorded together with time information and may be accumulated in respective time bins of a histogram.

The sampled event signals are transferred to the TDC 115, which converts time information from laser pulse transmission time point to a reflected light arrival time point into digital values. The time information generated in this manner is transferred to the histogram generator 116 and accumulated in respective bins of a time-axis histogram during one measurement frame.

The histogram generator 116 accumulates and generates a histogram corresponding to a plurality of transmission/reception cycles repeated during a frame, and each histogram bin represents a frequency of occurrence of photon events arriving in a specific time section.

According to an embodiment, the histogram generator 116 is configured to selectively store a histogram at a specific time point while continuously accumulating and generating the histogram during a single frame, in a state in which an accumulation operation is not interrupted (or regardless of the accumulation operation).

For this purpose, a plurality of histogram memories 117-1 to 117-4 may be connected to the histogram generator 116, and each memory may store histogram data corresponding to different accumulation time points in parallel, for example, as a snapshot.

Noise components of histogram data generated by the histogram generator 116 may be reduced through the FIR filter 122, and thereafter histogram peak positions are detected by the Echo/Peak Detector 123. Detected peak information or filtered histogram data may be transferred to the processor 300 through the MIPI interface 124.

The processor 300 may include an Application Processor (AP) 310, a memory 320, and an interface unit I/F 330. The Application Processor 310 performs distance calculation, post-processing operation, calculation of control parameters, and the like by using histogram data or peak information transferred from the light receiving unit RX 100. The memory 320 stores histogram data, distance calculation results, control information, and the like, and the interface unit 330 outputs processing results to an external host, a display apparatus, or a higher-level control system.

The light emitting unit TX 200 includes a TX driver 210 and an IR laser diode 220, and is configured to emit a laser pulse having a predetermined pulse width and repetition period according to a control signal (for example, TX Trigger).

The light emitting unit TX 200 may be driven in at least one of a frame unit driving manner or a pixel group unit driving manner. Transmission timing may be adjusted according to a control signal from a system controller (for example, 125) or the processor 300.

Meanwhile, each functional block illustrated in FIG. 1 does not mean a physically strictly separated configuration, and depending on an implementation form, some functional blocks in the light receiving unit RX 100 may logically perform functions of the processor 300. That is, FIG. 1 illustrates an example of an integrated implementation of the SPAD-based LiDAR system 1 for convenience of description, and a core of the present disclosure lies not in an arrangement itself of hardware blocks, but in a control and processing method for selectively securing a valid histogram before distortion in a process of accumulating and generating a histogram.

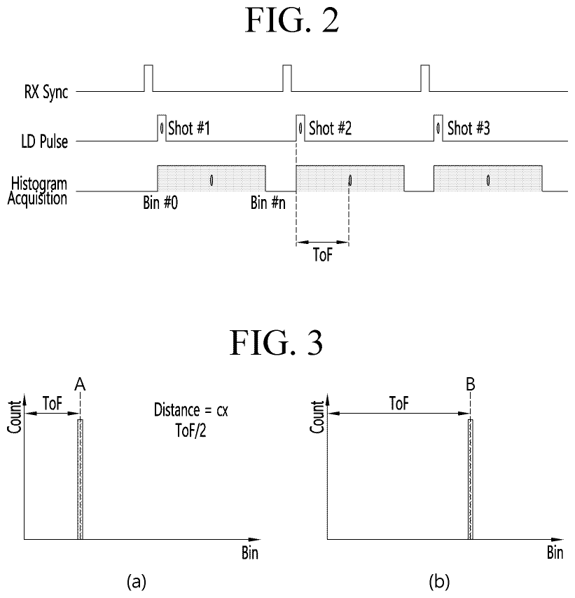

FIG. 2 is a view illustrating a basic frame-based driving timing structure in which laser transmission and reflected light reception are repeatedly performed during one frame F in the LiDAR system 1.

Referring to FIG. 2, during one frame F, a plurality of transmission/reception cycles are continuously performed, and each transmission/reception cycle is configured as a time structure including an RX Sync signal, an LD Pulse, and a Histogram Acquisition section.

When a laser pulse is transmitted in each transmission cycle (for example, Shot #1, Shot #2, Shot #3, . . . ), light irradiated by the laser pulse is reflected by an object and reaches the light receiving unit 100, and the reflected light is detected.

Reflected light events detected in each transmission/reception cycle are accumulated in a histogram bin corresponding to an elapsed time with respect to a laser pulse transmission time point. That is, according to a time point at which a reflected light event occurs during the histogram acquisition section, a time-axis histogram from Bin #0 to Bin #n is formed (or accumulated).

As illustrated in FIG. 2, a time difference between the laser pulse transmission time point and the reflected light detection time point corresponds to Time of Flight (ToF), and the ToF information is thereafter used as basic data for distance calculation.

According to an embodiment, a frame length and the number of transmission/reception repetitions within a frame are maintained at preset values, and during progress of one frame, an exposure time, a transmission count, or transmission timing of a laser is not changed. That is, FIG. 2 is a conceptual view for explaining a method of selectively storing and utilizing a histogram at a specific time point during a histogram accumulation process, without being based on a change in an exposure condition during a frame or control of a transmission parameter.

Accordingly, the frame-based driving structure illustrated in FIG. 2 provides a basic operating environment for understanding histogram storage time point control, histogram shape analysis, and adaptive processing techniques to be described later.

FIG. 3 is a view illustrating an example of a histogram generated in an ideal environment in which a single reflective object exists and signal distortion does not occur.

(a) of FIG. 3 and (b) of FIG. 3 exemplarily illustrate histogram responses for single objects located at different distances, respectively.

Referring to FIG. 3, on a time axis (bin axis) of the histogram, one clear peak corresponding to a single reflected signal, that is, a single peak, is formed. The peak is formed at a position corresponding to Time of Flight (ToF) from a laser transmission time point until reflected light is received, and a distance to an object is distinguished according to a difference in peak position. At this time, distance information d may be calculated by a relationship of d=c×ToF/2.

In addition, the peak illustrated in FIG. 3 has a constant width W1 determined by time resolution, a sampling width, and a receiving circuit characteristic of the system, and a shape of the peak generally exhibits a symmetrical distribution. Such a histogram shape represents a normal reflected response for a single object, and corresponds to a state in which accurate distance information can be reliably calculated based on a peak position and shape of the histogram.

(a) of FIG. 3 and (b) of FIG. 3 indicate that, although the position ToF of the peak moves according to a difference in distance of the object, the width and shape of the peak are substantially maintained. This indicates that, under an ideal condition, a change in distance does not cause distortion of the histogram shape or an abnormal increase in the peak width.

Accordingly, by setting the histogram illustrated in FIG. 3 as a reference histogram of a normal state, and comparing and analyzing how the histogram shape changes in a short-distance high-reflectance object, presence of a plurality of objects, or saturation and signal overlap occurring during an accumulation process, which are described later, necessity and effects of histogram selection and storage time point control according to the present disclosure are explained.

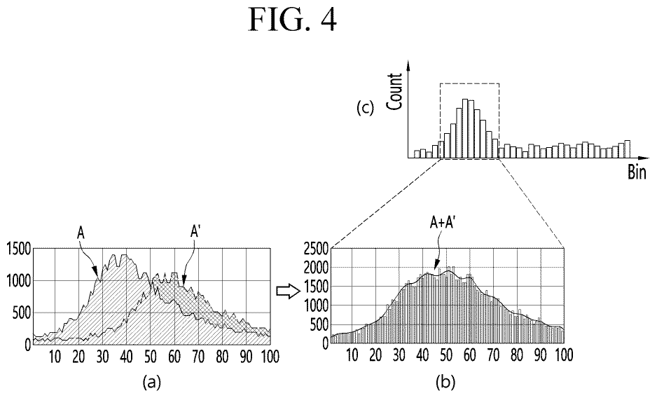

FIG. 4 is a view illustrating histogram saturation and signal overlap phenomena that may occur when a short-distance object or a high-reflectance object exists, or when a plurality of objects exist at temporally adjacent positions.

Referring to (a) of FIG. 4, a case in which a plurality of reflected signals A and A′ having different distances or reflection characteristics are adjacent to or partially overlap each other on a time axis (bin axis) is exemplarily illustrated. For example, the reflected signal A generated from a short-distance object or a high-reflectance object may have a relatively high count, and the reflected signal A′ generated from a long-distance object or an object having low reflectance may have a relatively low count. At this time, when arrival times of the two signals are close, the two signals may overlap each other on the time axis.

When the overlapped reflected signals as described above are repeatedly accumulated during one frame, as illustrated in (b) of FIG. 4, the individual reflected signals A and A′ are not separately identified, and, on an accumulated histogram A+A′, a shape similar to a single peak may be formed. At this time, in a specific time section of the histogram, a count value may increase so that, as illustrated in (c) of FIG. 4, a saturation region may be formed, and as a result, a width of the peak is abnormally expanded and a central position of the peak becomes inconsistent with an actual position of a reflective object.

Such histogram shape distortion may cause a distance error in a conventional method detecting a peak by using only a final histogram at a time point at which a frame ends. In particular, in a histogram after saturation or overlap has occurred, distance calculation based on a peak position may no longer accurately reflect ToF information.

In the present disclosure, instead of using an entire accumulation process of a histogram, by analyzing a change in a shape of the histogram, a time point before distortion due to saturation or overlap occurs may be detected, and a histogram formed at the corresponding time point may be selectively stored and used. Through this, by calculating distance information based on a normal histogram shape before progressing to a saturation and overlap state as in (b) of FIG. 4 or (c) of FIG. 4, reliability and accuracy of distance measurement can be improved even in an environment in which a short-distance high-reflectance object or a plurality of objects exist.

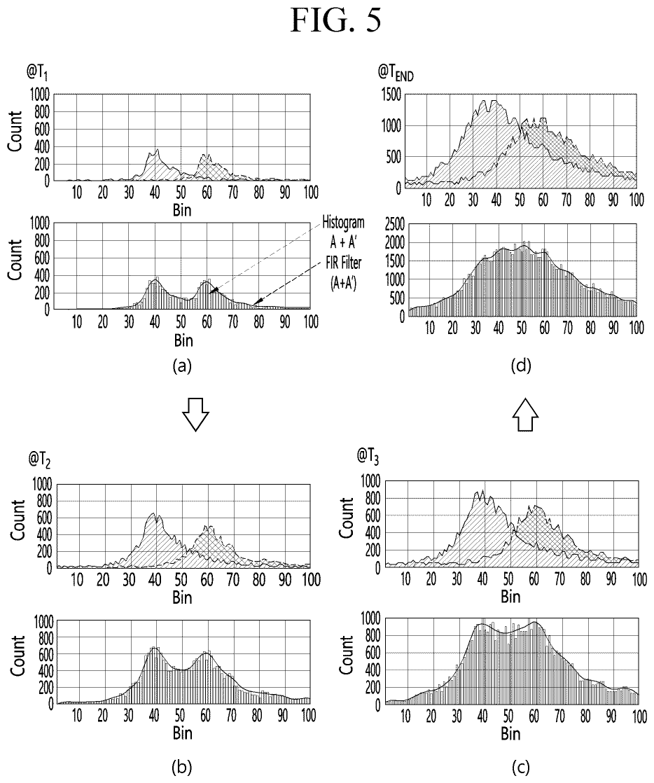

FIG. 5 is a view illustrating a phenomenon in which, when a plurality of objects located at different distances exist temporally adjacent to each other, reflected signals overlap each other and a histogram shape is gradually distorted in a process in which a histogram is accumulated during one frame.

(a) to (d) of FIG. 5 and time point indications of @T₁, @T₂, @T₃, and @T_END exemplarily illustrate how a histogram shape changes over time in a histogram accumulation process.

Referring to (a) of FIG. 5, at an initial accumulation time point @T₁, a histogram component A corresponding to a first object and a histogram component A′ corresponding to a second object appear in relatively distinguishable forms at respective ToF positions. In addition, at this time point, even if results of accumulation of the two components A+A′ partially overlap each other, a peak structure is relatively maintained, and thus distance information can be estimated. In (a) of FIG. 5, a result FIR filter (A+A′), in which the FIR filter 122 is applied to the accumulated histogram A+A′, is also illustrated, thereby showing that, even if noise is reduced through filtering, the overlap itself may remain.

Referring to (b) of FIG. 5, at a time point @T₂ at which accumulation has further progressed from the initial accumulation time point @T₁, as overlap the A and A′ components increases, a peak width of the accumulated histogram A+A′ increases, and distinction between peaks relatively decreases as compared with the previous state. That is distributions of the individual components A and A′ become wider and an overlapping section thereof increases, such that the distributions begin to be transformed into a form of one wide peak.

Referring to (c) of FIG. 5, at a time point @T₃ at which accumulation has further progressed from the time point @T₂, overlap is further intensified, such that a shape of the accumulated histogram A+A′ may change to an extent that the accumulated histogram A+A′ is mistaken for a single peak, and an abnormal distribution such as flattening of an upper portion of the peak may appear. At this time, even if the FIR filter 122 is applied, distortion of the peak, movement of a central position, and an increase in width due to overlap are not sufficiently resolved, and as a result, reliability of distance calculation based on a peak position is relatively reduced.

Referring to (d) of FIG. 5, at a frame end time point @T_END, it can be understood that the accumulation result of A and A′ overlaps each other more greatly than at the previous time point @T₃, and a peak width of the accumulated histogram has significantly increased as compared with a normal state (for example, the ideal histogram of FIG. 3). In such a state, it is relatively very difficult to accurately separate or calculate actual object distance information only by general peak-based processing such as single peak detection or centroid estimation, and when only a frame end histogram is used as in the conventional method, a possibility that a distance error occurs becomes high.

In the present disclosure, therefore, as illustrated in FIG. 5, an increase in a histogram peak width or a shape change in the histogram is intended to be used as an index of histogram distortion in a histogram accumulation process. That is, by detecting a time point at which a peak width of the histogram increases to be equal to or greater than a preset threshold value or a peak shape begins to change abnormally during the accumulation process, and selectively storing a histogram corresponding to a previous time point thereof (@T₁ or @T₂, and the like) (Tv storage) and using the histogram for subsequent distance calculation, reliable distance information can be acquired without depending on the final histogram @T_END in which overlap has been intensified.

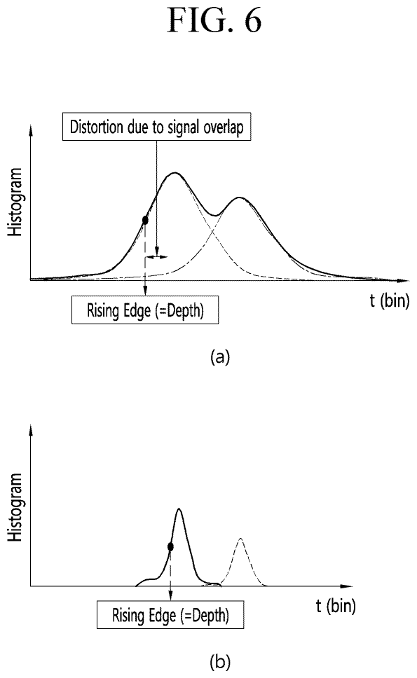

FIG. 6 is a view for explaining a concept of an index for quantitatively evaluating quality of a histogram based on a peak width of the histogram.

In the present disclosure, whether distortion due to overlap or saturation occurs is determined by using a shape of a histogram, particularly a change in a peak width.

Referring to FIG. 6, Width-to-Expected-Ratio (WER), which is a quality index of a histogram, is defined as a ratio of a full width at half maximum (FWHM_measured) of a measured histogram peak to a reference full width at half maximum (FWHM_expected) expected in a normal state. Here, the reference full width at half maximum (FWHM_expected) may represent a reference peak width determined by time resolution, a sampling width, and a receiving circuit characteristic of a system under an ideal condition in which a single reflective object exists and signal overlap or saturation does not occur.

The histogram peak means a local maximum of a count value detected in the histogram, and may represent a time position corresponding to a reflected signal.

According to an embodiment, in order to quantitatively express a width of a histogram peak, FWHM (Full Width at Half Maximum) may be used. The FWHM means a time difference between a left crossing point and a right crossing point at a height corresponding to half of a maximum count value of the histogram peak. That is, a count level corresponding to 50% of the value may be set based on a maximum value of the histogram peak, and a time width between two points at which the corresponding level and a histogram curve cross each other may be defined as the FWHM.

In general, in a case of a normal histogram formed by a single reflector, the FWHM has a relatively narrow value determined by time resolution of a system and a laser pulse width. On the other hand, when a plurality of reflected signals temporally adjacent to each other overlap each other or a histogram shape is expanded due to an influence such as sensor saturation, the FWHM value may increase. Accordingly, the FWHM of the histogram may be used as an index indicating a degree of expansion of the histogram shape, and may be utilized as an index for determining whether histogram distortion or signal overlap occurs.

According to an embodiment, in order to quantitatively evaluate a width change of the histogram, WER may be used as a histogram quality index.

The WER may be defined as a ratio obtained by comparing a full width at half maximum (FWHM_measured) of a measured histogram peak with a reference full width at half maximum (FWHM_expected) expected in a normal state. That is, the WER may be expressed by Equation 1 below.

WER=FWHM_measured/FWHM_expected [Equation 1]

Here, the reference full width at half maximum (FWHM_expected) may mean a normal histogram peak width determined by a laser pulse width, a time response characteristic of a sensor, time resolution of a system, and the like.

In general, in the case of a normal histogram formed from a single reflector, a WER value may be close to 1, and when a plurality of reflected signals temporally overlap each other or a saturation phenomenon occurs, the WER value may increase. When the WER value increases to be equal to or greater than a predetermined threshold value, it may be determined that a histogram shape deviates from a normal state and is distorted by overlap or saturation.

According to an embodiment, the histogram quality index WER may be used as a criterion for determining whether a histogram shape is normal. In general, in the case of a normal histogram formed by a single reflector, the WER value may have a value close to about 1.0, which may mean that the measured full width at half maximum substantially matches the full width at half maximum expected in the system.

On the other hand, when a plurality of reflected signals temporally adjacent to each other overlap each other or histogram saturation occurs, a width of the histogram peak increases, such that the WER value may increase. For example, in an embodiment, when the WER value exceeds about 1.5, it may be determined that a possibility of overlap of a plurality of reflected signals exists, and when the WER value increases to about 2.0 or more, it may be determined that histogram distortion is in a severe state.

Accordingly, a storage time point controller according to an embodiment may determine a time point at which the WER value exceeds a preset reference value as a time point at which histogram distortion starts, and may determine the corresponding time point or a previous time point thereof as a histogram storage time point. The reference value may be adjusted according to a system characteristic, a laser pulse width, a sensor time response characteristic, or a measurement environment, and is not limited to a specific value.

(a) of FIG. 6 exemplarily illustrates a case in which a plurality of reflected signals temporally overlap each other, and illustrates a phenomenon in which a histogram peak becomes wider and has an asymmetric shape, and due thereto, a Rising Edge of the histogram, which is a reference point of distance calculation, is distorted. In this case, the measured full width at half maximum (FWHM_measured) becomes significantly increased compared with the reference full width at half maximum (FWHM_expected), and accordingly, the WER value has a value greater than 1.

On the other hand, (b) of FIG. 6 exemplarily illustrates a histogram in a normal state in which reflected signals are sufficiently separated, and a width of a peak is narrow, a shape thereof is stable, and a Rising Edge is clearly defined. In this case, the measured full width at half maximum (FWHM_measured) is close to the reference full width at half maximum (FWHM_expected), and the WER value has a value close to 1.

Accordingly, as the WER value is closer to 1, the histogram is closer to a normal state, and as the WER value increases, a possibility that the histogram shape is distorted by overlap or saturation is higher. In the present disclosure, by using the WER value as a criterion for determining histogram quality, a time point before the shape of the histogram is distorted is detected during a histogram accumulation process, and a histogram at the corresponding time point is selectively stored, thereby improving reliability of distance measurement.

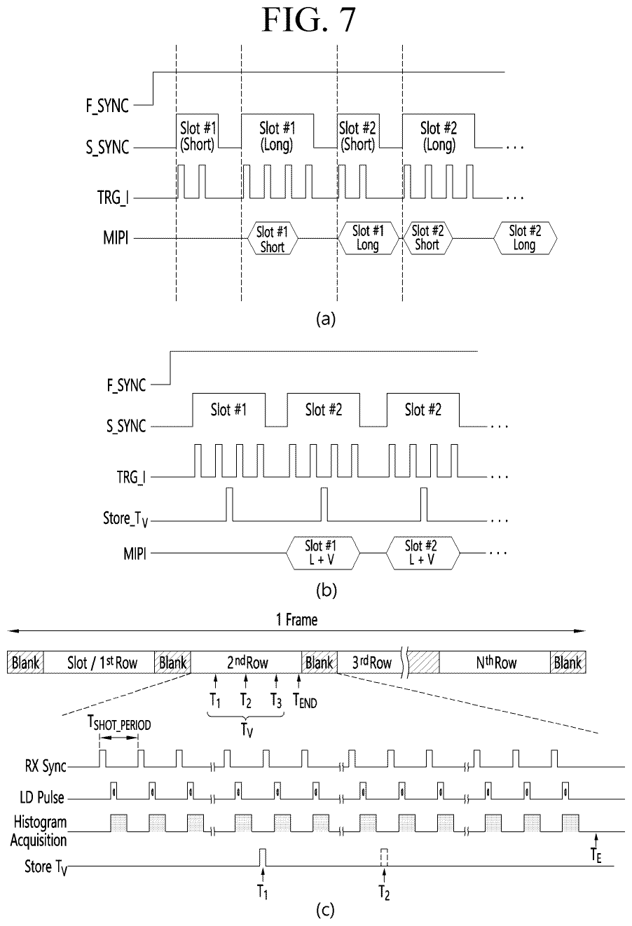

FIG. 7 is a view illustrating, in comparison with a conventional Long+Short exposure-based driving method, how a histogram storage time point Tv control method according to the present disclosure is implemented within a frame structure, and how stored histogram information may be included in a transmission structure.

(a) of FIG. 7 illustrates an example of driving of a conventional Long+Short method, (b) of FIG. 7 illustrates an example of driving of the present disclosure, and (c) of FIG. 7 illustrates a specific timing example in which histogram accumulation and a storage signal Store_Tv occur within one frame.

First, referring to (a) of FIG. 7, in a conventional Long+Short mode driving method, during one frame operation, a slot corresponding to Short exposure and a slot corresponding to Long exposure are temporally separated and performed. For example, according to a frame sync F SYNC and a slot sync S SYNC, Slot #1 (Short), Slot #1 (Long), Slot #2 (Short), Slot #2 (Long), and the like are sequentially performed, and a trigger signal TRG_I is generated corresponding to each slot. In addition, since measurement results acquired in respective slots are respectively transmitted through an interface MIPI, as the number of slots increases, a transmission data amount may increase and a transmission timing structure may become complicated. Furthermore, since a time interval exists between a Short slot and a Long slot, when a moving object exists, reflected signals for the same object are acquired with temporal inconsistency, such that reliability of distance calculation may be reduced.

Meanwhile, in a conventional HDR LiDAR system, a method is used in which a plurality of measurement sections having different exposure times (for example, Long exposure and Short exposure) are separately performed, and dynamic range is expanded by combining respective measurement results. However, such a method requires separate measurement slots for the plurality of exposure sections, and accordingly, a measurement frame structure may become complicated or additional time overhead may occur. In addition, since data acquired in different exposure sections are measured at different time points, there is a possibility that a measurement error occurs in a moving object environment.

In contrast, a method according to an embodiment of the present disclosure provides a structure in which, rather than using a plurality of measurement frames having different exposure times, a histogram at a time point Tv before distortion occurs is selectively stored by analyzing a change in a histogram shape within a single histogram accumulation process.

That is, in an embodiment of the present disclosure, a change in a histogram shape may be detected by using a peak width FWHM of a histogram or a histogram quality index based thereon (for example, WER), and a histogram generated at a time point immediately before the quality index reaches a preset reference value (or a time point immediately before the quality index exceeds the preset reference value) may be selected as a histogram at a storage time point Tv.

Accordingly, according to an embodiment of the present disclosure, even without separately performing a plurality of exposure sections, a valid histogram before distortion occurs can be secured within a single measurement frame. Accordingly, while maintaining a frame structure simple, accuracy and a dynamic range of distance measurement can be improved. In addition, since a histogram is selectively stored in the same accumulation process, more stable distance measurement is possible even in a moving object environment.

On the other hand, referring to (b) of FIG. 7, in the present disclosure, while a basic driving signal system such as a frame sync F SYNC, a slot sync S SYNC, and a trigger signal TRG_I is maintained, a storage signal Store_Tv for controlling a histogram at a selected time point to be stored during a histogram accumulation process is additionally defined.

At this time, the storage signal Store_Tv may be generated in a pulse form at a time point before histogram distortion is intensified in earnest, by detecting a change in a histogram shape (for example, a peak width or a quality index based thereon) within a frame. In addition, in terms of transmission structure, the present disclosure may combine a Long measurement result and a storage result at a time point Tv (a Variable histogram or information calculated therefrom) in units of slots, and may transmit the same by combining the same into a single transmission unit, for example, Slot #1 (L+V), Slot #2 (L+V). Accordingly, not only effects of expanding a dynamic range and suppressing distortion can be obtained without separately operating Short/Long slots as in the related art, but also overhead in terms of transmission and frame timing can be reduced.

Referring to (c) of FIG. 7, one frame (1 Frame) may be configured of a plurality of slots or row scan sections, and histogram accumulation is performed in a specific section within the frame. As illustrated at a lower portion of (c) of FIG. 7, while repeated transmission/reception is performed by an RX Sync and an LD Pulse, Histogram Acquisition is activated, and as a result, a time-axis histogram is gradually accumulated.

In the present disclosure, at least one of plurality of candidate time points T₁, T₂, T₃, and T_END during the accumulation process may be selected as a histogram storage time point Tv. Further, as the Store_Tv signal is generated at the selected time point, a histogram at the corresponding time point (or a parameter derived therefrom) is stored. For example, when Store_Tv is generated at T₁ or T₂, histogram information in which distortion is not yet intensified can be secured before reaching a frame end time point T_END, and thus reliability of distance calculation can be improved as compared with a conventional method depending only on a frame end histogram.

In addition, as illustrated in (c) of FIG. 7, since the Store_Tv signal is generated only at a necessary time point within a frame, a storage time point can be controlled without changing a frame length or the number of transmission repetitions.

FIG. 7 explains that, while a conventional Long+Short method may cause an increase in transmission amount and timing complexity due to slot separation and may be vulnerable to a moving object, the present disclosure can selectively determine a storage time point Tv in an accumulation process within a frame (Store_Tv), and can efficiently include a result thereof in a transmission structure. Accordingly, according to the present disclosure, reliability and a dynamic range of histogram-based distance measurement can be improved without changing a frame structure or separately operating exposure conditions.

As illustrated in FIG. 7, in a conventional LiDAR system, in order to solve a saturation or overlap problem of a histogram, a method of dividing and operating one frame into a plurality of exposure conditions (for example, Long/Short exposure), or a method of changing a frame structure itself, has been mainly used, but such a conventional method may cause problems such as complication of a transmission structure due to slot separation, discontinuity of frame timing, distance inconsistency in a moving object environment, and an increase in system resources.

In contrast, in the method of the present disclosure illustrated in (b) of FIG. 7 and (c) of FIG. 7, while maintaining a frame structure and the number of laser transmission/reception repetitions as they are, a process itself in which a histogram is accumulated is observed, and a valid histogram is selectively secured based on a time point at which a shape of the histogram changes during the process. That is, the present disclosure is based not on a method of separating exposure conditions afterward or combining a plurality of results, but on a method of capturing information before distortion by using temporal evolution of a histogram within one frame.

To this end, the present disclosure discloses a structure capable of analyzing an accumulation state of a histogram in real time or quasi-real time during a frame, detecting a time point at which a shape of the histogram starts to deviate from a normal state, and storing a histogram at the corresponding time point in a state in which an accumulation operation is not interrupted. In other words, the present disclosure discloses a structure in which histogram generation, histogram quality analysis, storage time point determination, and distance calculation are organically linked within a frame.

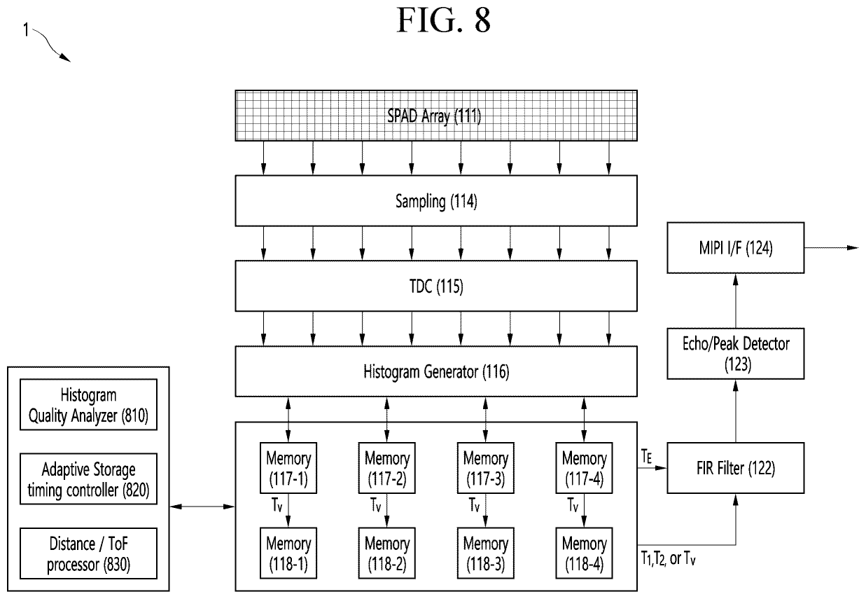

Accordingly, FIG. 8 discloses an example of an internal logic structure for adaptively determining a storage time point Tv based on a shape change of a histogram, and selectively storing and processing a histogram at the corresponding time point.

The in-frame storage time point control Store_Tv conceptually presented in FIG. 7 explains, in FIG. 8, an example of implementation through specific functional blocks, for example, a histogram quality analyzer, an adaptive storage timing controller, a distance/ToF processor, and the like.

In other words, FIG. 7 explains a temporal/conceptual operating principle of the present disclosure, and FIG. 8 explains a structural or functional configuration for implementing the operating principle inside the SPAD-based LiDAR system 1.

Hereinafter, with reference to FIG. 8, contents from histogram generation to quality analysis, storage time point determination, and distance calculation will be described in more detail.

FIG. 8 is a view schematically illustrating a histogram generation, storage, and processing structure for implementing an embodiment according to the present disclosure, and is, in particular, a view for explaining an internal logic structure for adaptively determining a histogram storage time point Tv based on a shape change of a histogram.

As described through FIG. 7 above, in the SPAD-based LiDAR system 1, as a histogram is accumulated and generated during one frame, a histogram peak width may gradually increase due to the presence of a short-distance high-reflectance object or a plurality of objects, or a histogram shape may be distorted due to saturation or overlap.

FIG. 8 illustrates a specific configuration and operating principle for selectively securing a valid histogram at a time point before such histogram distortion starts to occur in earnest.

Referring to FIG. 8, photon events detected by the SPAD array 111 are converted into time information corresponding to an arrival time of reflected light through the sampling circuit 114 and the TDC 115. The converted time information is transferred to the histogram generator 116 and accumulated in respective bins of a time-axis histogram during one frame. This histogram accumulation operation is continuously performed from a frame start time point to a frame end time point, and a frame structure itself is maintained.

One or more histogram memories 117-1 to 117-4 may be connected to the histogram generator 116, and these histogram memories 117-1 to 117-4 may be used as storage regions for storing histograms at different time points during a histogram accumulation process. At this time, in the present disclosure, a histogram storage operation does not interrupt or replace the histogram accumulation operation, but performs an operation of storing, in parallel, a histogram at a specific time point during the accumulation process (for example, a storage operation in a form of a snapshot). Accordingly, in the present disclosure, histogram accumulation may continue to be performed until the frame end time point even after the storage time point.

According to the present disclosure, the histogram storage time point may not be determined simply by whether a frame ends, an absolute size of an accumulated count, or a preset time. Instead, the histogram quality analyzer 810 illustrated in FIG. 8 receives histogram data accumulated up to a current time point from the histogram generator 116 and analyzes a shape change of the histogram. Specifically, the histogram quality analyzer 810 may evaluate histogram quality by analyzing at least one of a width of a histogram peak, a degree of expansion of a distribution, a possibility of occurrence of multiple peaks, or shape asymmetry.

According to an embodiment, the histogram quality analyzer 810 may calculate a full width at half maximum (FWHM) of the histogram peak, and may calculate a histogram quality index WER by comparing the full width at half maximum with a reference full width at half maximum expected in a normal state. Such a quality index may be used as a quantitative criterion for determining whether a shape of the histogram starts to be distorted due to overlap or saturation. However, the present disclosure is not limited in that a histogram quality evaluation method is limited to a specific index or a specific calculation method, and various indices capable of reflecting whether a shape of the histogram changes may be applied.

A result of the histogram quality analysis is transferred to the adaptive storage timing controller 820.

According to an embodiment, a histogram may be cumulatively generated in a process transmitting and receiving a plurality of optical pulses, and a shape change of the histogram may be analyzed periodically or after a predetermined number of measurements in the process in which the histogram is accumulated.

Specifically, the controller or a signal processor may calculate, for the accumulated histogram, a peak width (for example, FWHM) or a histogram width index (for example, WER).

When the calculated histogram width index exceeds a preset reference value, it may be determined that histogram distortion has started to occur, and in this case, a histogram generated at an accumulation time point immediately before exceeding the reference value may be determined as a histogram at a storage time point Tv.

In an embodiment, the histogram at the time point Tv may be stored in a separate memory or buffer, and thereafter, in a distance calculation process, a distance to an object may be calculated by using the histogram at the time point Tv instead of the histogram at the frame end time point.

In addition, calculation of the histogram width index may be repeatedly performed at a plurality of intermediate time points of the histogram accumulation process. The reference value may be set based on time resolution of a system, a laser pulse width, or characteristics of a SPAD sensor.

The adaptive storage timing controller 820 determines, based on the histogram quality analysis result, a time point before histogram distortion occurs as the histogram storage time point Tv. For example, while the histogram quality index is equal to or less than a predetermined reference value, histogram accumulation may continue to be performed, and when a time point at which the quality index exceeds the reference value or a sudden change is detected is reached, the corresponding time point may be determined as the storage time point Tv.

According to an embodiment, the storage time point Tv may be set based on a histogram corresponding to a time point at which the histogram quality index reaches or exceeds the reference value or immediately before the time point. For example, when the quality index reaches or exceeds the reference value in the histogram accumulation process, a histogram corresponding to a time point before histogram distortion starts to occur in earnest may be selectively stored. Through this, even without interrupting histogram accumulation during an entire frame, distance information can be calculated by using a normal histogram shape before distortion.

The adaptive storage timing controller 820 controls the histogram generator 116 and the histogram memories 117-1 to 117-4 so as to selectively store a histogram corresponding to the storage time point Tv. At this time, storage time point control is performed in parallel with the histogram accumulation operation, and due to the storage operation, a frame structure is not changed and transmission/reception repetition is not interrupted. Accordingly, at the frame end time point, both the histogram at the storage time point Tv and the histogram accumulated until the frame end time point may be secured.

The distance/ToF processor 830 illustrated in FIG. 8 performs distance calculation by using the stored histogram.

According to the present embodiment, the distance/ToF processor 830 may preferentially use, not the histogram at the frame end time point, but the histogram stored at a time point at which histogram quality is maintained, to detect a histogram peak position and calculate a Time of Flight (ToF) and a distance value based thereon. Through this, even when the histogram is saturated or overlapped at the frame end time point, stable distance measurement becomes possible based on a valid histogram before distortion.

In addition, determination of the histogram storage time point according to the present embodiment may be performed independently of whether an exposure time, a transmission count, a sampling width, or a filter parameter is changed. That is, the histogram storage time point control is not a control operation that replaces or necessarily accompanies exposure control or sampling control, but is a control operation performed based on a shape change of the histogram itself. If necessary, an exposure time, a sampling width, or a processing parameter may additionally be adjusted in association with a histogram quality analysis result, but this is not an essential configuration of the present disclosure.

As a result, the histogram quality analyzer 810, the adaptive storage timing controller 820, and the distance/ToF processor 830 illustrated in FIG. 8 are functional blocks for selectively securing valid distance information before histogram distortion occurs in a process of accumulating and generating a histogram during one frame, and perform a role of effectively improving distance measurement reliability and a dynamic range of the SPAD-based LiDAR system 1 without changing a frame structure.

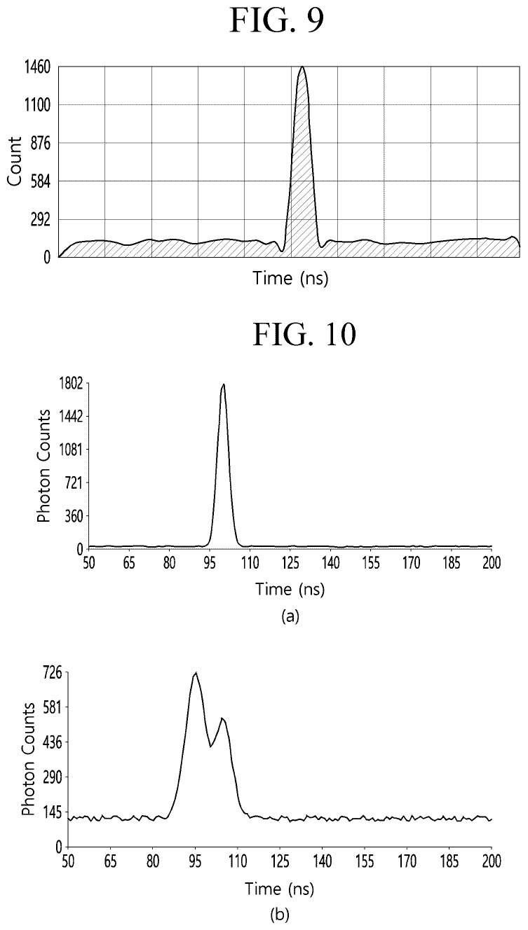

FIG. 9 is a view illustrating an example of a result of applying FIR filtering to a time-axis histogram accumulated during a frame or a histogram secured as a snapshot at a storage time point Tv in the SPAD-based LiDAR system 1 according to the present embodiment.

A horizontal axis of FIG. 9 represents time (Time), and a unit thereof is ns (nanoseconds), and a vertical axis represents a histogram count (Count). The histogram count means an accumulated amount of photon events detected within a predetermined time section (bin) for digital counts corresponding thereto), and is used as basic data for distance measurement.

In a waveform illustrated in FIG. 9, a sharp peak that rapidly rises in a specific time section is observed above a flat baseline (bottom level). The peak corresponds to a time distribution in which reflected light with respect to a transmitted laser pulse is received, and a central position (or a rising edge, a maximum point, and the like) of the peak may be directly used for ToF estimation. That is, a time delay at which the peak appears may be defined as t_ToF, and a distance may generally be calculated by the following relational expression d=c·t_ToF/2 (where c is the speed of light). Therefore, stably estimating a peak position is key to distance accuracy.

However, in an actual environment, a baseline of a histogram may fluctuate due to ambient light, multiple reflection, sensor noise, a dark count of a SPAD, a TDC quantization error, and the like, or noise in a form of a ripple or a spike may occur around a peak.

In the present disclosure, the FIR filter 122 may reduce such a high-frequency component or accidental spike-like noise to smooth a histogram peak shape and improve reliability of estimation of a peak position and a width (for example, FWHM). In particular, since the present disclosure calculates a quality index such as WER based not on an absolute magnitude of a count but on a change in a histogram shape (for example, width/distribution/slope), when shape estimation is stabilized through the FIR filter 122, errors in storage time point Tv determination and subsequent distance calculation are reduced.

In addition, the waveform of FIG. 9 illustrates that a baseline may be maintained at a low level rather than being completely 0 in a section other than the peak. This means that a count of a certain level may be continuously accumulated due to ambient light or system noise. By alleviating such baseline fluctuation, application of the FIR filter can reduce false detection when, for example, a peak detector identifies a peak by various methods such as maximum value search, detection of a section exceeding a threshold value, and rising-edge-based trigger. In other words, FIG. 9 specifically illustrates that visibility and estimation stability of a peak can be secured through histogram processing (filtering), and a result thereof can be used for WER determination and distance calculation.

(a) of FIG. 10 illustrates an example of a histogram acquired under a relatively good condition (for example, an environment in which ambient light is low, a single reflector is dominant, and a signal-to-noise ratio (SNR) is high) in the LiDAR system 1 according to the present disclosure.

A horizontal axis of (a) of FIG. 10 represents time and a unit thereof is ns, and a vertical axis represents a photon count. For example, referring to (a) of FIG. 10, it can be seen that a single clear peak is formed in a specific time section, and a periphery of the peak has a relatively smooth and symmetrical shape. This means that reflected light events are concentrated and accumulated in a specific ToF section, and suggests that a representative time value t_ToF required for distance calculation can be stably estimated. In addition, a full width at half maximum (FWHM) of the peak appears relatively small, illustrating a state in which a large expansion does not occur with respect to a reference full width at half maximum (FWHM_expected) of the system. Accordingly, a WER value may be calculated as a low value close to 1 or equal to or less than a threshold value, and a condition of (a) of FIG. 10 (for example, WER≈1.5) may be treated as a “normal or quasi-normal” category in the present disclosure.

In the present disclosure, WER may be regarded as quantifying, not simply that “a peak is large/small,” but “how much a peak width has expanded relative to a reference,” through overlap/saturation/distortion possibility.

In a waveform such as (a) of FIG. 10, since a peak width is narrow and a rising edge is clear, even when the peak detector 123 or the distance/ToF processor 830 applies maximum value search, rising-edge-based detection, or centroid calculation, a result does not significantly fluctuate. Furthermore, even when a histogram at a specific time point Tv is stored as a snapshot in a histogram accumulation process, there is a high possibility that a shape difference between a histogram at the storage time point and a histogram at a frame end time point is not large, such that stable distance estimation is possible without the storage time point Tv selection logic indiscriminately performing unnecessary storage.

Accordingly, (a) of FIG. 10 may be regarded as an example in a case in which WER is low and a peak shape is good, and may indicate that a controller can select a simple processing path (for example, ToF calculation based on a single peak), determine that distortion risk is low even when delaying a storage time point, or perform normal output without a remeasurement request. That is, (a) of FIG. 10 is an example illustrating that WER-based quality determination corresponds to stability of an actual histogram waveform.

(b) of FIG. 10 illustrates an example of a histogram acquired under a relatively poor condition (for example, an environment in which ambient light increases, a plurality of objects having a large reflectance difference exist, a short-distance high-reflectance object and a long-distance low-reflectance object simultaneously exist, and multiple reflection or signal overlap is highly likely to occur) in the LiDAR system 1.

A horizontal axis and a vertical axis of (b) of FIG. 10 are the same as those of (a) of FIG. 10 described above.

Referring to (b) of FIG. 10, it can be seen that, compared with (a) of FIG. 10, a peak is relatively wide, a shoulder or a multiple peak shape appears around the peak, and baseline fluctuation is also relatively large.

Such a waveform suggests, rather than being an ideal response of a single reflector, a possibility that different ToF components are temporally adjacent and accumulated (overlap), or that a peak shape is deformed because some sections are excessively accumulated in a histogram accumulation process. Accordingly, a full width at half maximum (FWHM_measured) of the peak may greatly increase compared with a reference full width at half maximum (FWHM_expected), and a WER value may be calculated to be large (for example, WER≈6.0). This may be interpreted as a state in which a possibility of histogram distortion is high and reliability of distance calculation may be reduced.

Therefore, in such a case, when single peak detection is performed by using only a frame end histogram, components corresponding to a plurality of objects may be combined into one wide peak. Due thereto, a problem may occur in which movement of a peak center, maximum value bias, or easing of a rising edge occurs, and thus a threshold-value-based detection time point fluctuates. That is, even when the same distance estimation algorithm is applied, if a histogram shape is unstable, a ToF estimation error increases, and as a result, a distance error or failure in object separation may occur. Accordingly, as illustrated in (b) of FIG. 10, it is intuitively shown that, as WER becomes larger, it is difficult to calculate a reliable distance only by simple peak position estimation.

In the present disclosure, in order to alleviate such a situation, WER or a histogram peak shape change is monitored during a histogram accumulation process, and a histogram is stored as a snapshot by selecting a time point Tv immediately before or immediately after WER exceeds a threshold value. In particular, under a poor condition, since overlap/saturation may be further intensified when accumulation continues until a frame end, there is a high possibility that a histogram stored in a middle of the frame contains more valid distance information. In addition, when WER is high, it may be designed to select an advanced processing path such as multiple peak separation (for example, Gaussian fitting, calculation of a plurality of ToF candidates), a remeasurement request after reliability verification, and change of a sampling width or a filter parameter. In this regard, (b) of FIG. 10 may be regarded as indicating necessity of the branch logic described above.

In other words, (b) of FIG. 10 illustrates that, in a situation in which WER is large, a histogram waveform becomes wide and unstable, and this directly leads to an increase in uncertainty of distance calculation. Accordingly, it can be explained that Tv storage/selection and quality-index-based control are required according to the present disclosure.

According to an embodiment, a histogram corresponding to the storage time point may be acquired by reading and storing histogram data accumulated up to the corresponding time point in an internal memory or buffer during a histogram accumulation process. At this time, histogram accumulation may continue thereafter, and the stored histogram may be maintained as a histogram in a form of a snapshot representing a histogram state accumulated up to the storage time point. For example, the histogram may include count values for a plurality of time sections (bins), and the histogram corresponding to the storage time point may be acquired by reading and storing accumulated count values in the respective time sections.

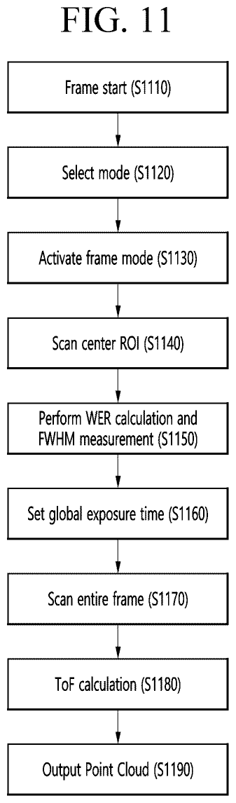

FIG. 11 is a flowchart illustrating an example of an overall processing procedure performed when the SPAD-based LiDAR system 1 operates in a frame unit control mode.

Referring to FIG. 11, within one frame period, histogram quality is evaluated through an ROI scan corresponding to a pre-scan, and, based on a result of the evaluation, a global exposure time (or an equivalent measurement intensity parameter) to be commonly applied to an entire frame is set, and thereafter an entire frame scan is performed to calculate ToF and output a Point Cloud.

That is, in the present disclosure, without complexly dividing a frame structure itself (for example, a transmission count/frame length), a measurement condition is selected by using a shape of a histogram (for example, a peak width) and a quality index based thereon (for example, WER), and valid information at a time point before distortion (for example, saturation/overlap) occurs is secured and used. However, in the above, in setting the global exposure time, a storage time point Tv is determined according to a histogram quality analysis result, and, if necessary, an exposure time, a sampling width, or a processing parameter may be additionally set.

First, in step S1110, the system 1 declares a frame start. The frame start means a time point at which repetition of laser pulse transmission of the light emitting unit TX 200 and SPAD event detection and time tagging (for example, TDC measurement) of the light receiving unit RX 100 are started. The frame start may be internally defined by a frame synchronization signal or a frame counter of a controller.

In step S1120, the controller performs mode selection. The mode selection may be determined according to, for example, whether a: fast frame rate has priority, whether distance accuracy or object separation performance has priority, whether a current environment (for example, ambient light/reflectance/possibility of presence of multiple objects) is poor, and the like.

As a result of the mode selection, when it is determined that it is appropriate to apply a single measurement condition on a frame basis, frame mode activation is performed in step S1130. Here, the frame mode activation means setting such that a global parameter (for example, a global exposure time, a global transmission repetition count, a global sampling width, and the like) is commonly applied to all pixels/regions of the frame.

Next, in step S1140, a center ROI scan (for example, 10×10 pixels) is performed. This is a procedure for preliminarily identifying a signal characteristic in a limited space (ROI) before scanning an entire frame. The center ROI is generally located at a center portion of an optical system, and thus has an advantage in that light reception sensitivity is relatively stable and a signal characteristic representative of an entire frame environment can be estimated at a relatively low cost. During the center ROI scan, the system 1 repeatedly performs laser transmission/reception to generate a histogram, and observes a peak position, a peak width, a baseline (for example, ambient light), and the like of the histogram.

Subsequently, in step S1150, WER calculation and FWHM measurement are performed. Here, the FWHM is an index indicating a width of a histogram peak, and, in a single object response, has a relatively narrow width limited by time resolution of a system. On the other hand, when overlap of signals of a plurality of objects, saturation, multiple reflection, or the like occurs, the peak width may expand or a shoulder or multiple peak shape may appear. The WER may be defined as a quality index obtained by normalizing a degree of expansion of such a peak width by comparing the degree of expansion with a reference state (for example, an expected width in an ideal/normal state), and, as the WER increases, a possibility of distortion may be determined as increasing. That is, step S1150 is an analysis step for determining a measurement condition of an entire frame based on histogram shape quality, rather than simply determining whether a signal is strong or weak.

In step S1160, a global exposure time may be set based on a result of step S1150. Here, the global exposure time is a parameter for improving signal quality observed in the center ROI, and, for example, when a signal is excessively strong and there is a risk of saturation or concern that a peak width may expand, exposure may be reduced (or, equivalently, a transmission repetition count/integration intensity may be reduced), and, when a signal is weak and SNR is insufficient, exposure may be increased to improve peak detection stability. However, in the present disclosure, unlike an HDR method in which a frame is divided into a plurality of exposures and separately performed, a valid section is secured by a shape-based index (for example, WER and the like) while maintaining a basic structure of the frame. Accordingly, setting of the global exposure time may be selectively included according to system implementation, and may also be replaced with a form of adjusting a sampling width or a filter parameter instead of the exposure time.

In next step S1170, an entire frame scan is performed. In this step, all pixels or scan target regions in the frame are sequentially measured according to a global parameter (for example, a global exposure time), and histogram accumulation/filtering/peak detection is performed for each pixel (or each pixel group). In particular, in the present disclosure, an operation (selective storage) of selectively storing a time point Tv before histogram quality deteriorates may be performed in parallel in the histogram accumulation process, and through this, reliability of distance calculation can be increased by using a pre-distortion histogram rather than a distorted histogram at a frame end time point.

In step S1180, ToF calculation is performed by the distance/ToF processor 830. The ToF calculation is a process of estimating a peak position (for example, a maximum point, a rising edge, a centroid, and the like) in a histogram and converting a time delay thereof into a distance. When the WER is low and a single peak is clear, simple processing (for example, based on a maximum point of a single peak) may be applied, and, when the WER is high or multiple peaks are suspected, advanced processing such as Gaussian fitting may be selected.

Finally, in step S1190, Point Cloud output is performed. Here, the Point Cloud includes a distance value for each pixel/direction and, if necessary, a reflection intensity, reliability (quality index), and the like, and may be transmitted to an external host (not shown) and used for 3D reconstruction, object recognition, environment awareness, and the like.

The flowchart of FIG. 11 described above explains a procedure of determining a global condition through ROI-based quality analysis (WER/FWHM) in the frame unit control mode, and stably performing an entire frame scan and ToF calculation.

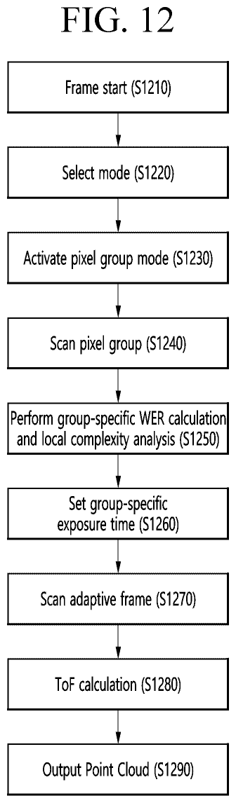

FIG. 12 is a flowchart illustrating an example of a procedure performed when the SPAD-based LiDAR system 1 operates in a pixel group unit control mode.

Compared with the frame unit control mode of FIG. 11, FIG. 12 is different in that, instead of applying a single global parameter to an entire frame, group-specific quality analysis (WER and the like) and group-specific exposure or equivalent parameter optimization are performed for a plurality of spatially divided pixel groups.

Through this, even when regions having greatly different reflectance coexist in a scene (for example, a region including a short-distance high-reflectance object and a region including a long-distance low-reflectance background), or even when an influence of ambient light appears differently according to position, overall balanced distance reliability and a dynamic range can be secured.

First, in step S1210, a frame start is performed. The frame start is a step of setting a reference section of transmission/reception repetition, and thereafter enables pixel group unit scans to be sequentially performed or performed according to scheduling within the same frame.

In step S1220, the controller performs mode selection. At this time, the mode selection may be configured to select a pixel group mode in, for example, a situation in which accuracy or reliability has priority over a frame rate, a situation in which there is a concern that saturation/non-detection may simultaneously occur because a reflectance distribution in a scene is very non-uniform and cannot be addressed only by global exposure, a situation in which a possibility of overlap of multiple objects is high, and the like.

In step S1230, pixel group mode activation is performed. When the pixel group mode is activated, a sensor array or an image plane is divided into a plurality of groups. A configuration of the groups may vary according to implementation, but may be, for example, in units of N×M blocks, variable groups based on a specific ROI, or units of regions dynamically defined according to a reflection intensity distribution. At this time, each group may be given a separate measurement condition (for example, an exposure time, a sampling width, a transmission repetition count, a storage time point Tv policy, and the like), and a configuration limiting a parameter change width between adjacent groups is also possible in order to maintain continuity at a group boundary.

Next, in step S1240, a pixel group scan is performed. This is a process of sequentially selecting each group in a frame, and collecting events of pixels belonging to the corresponding group and generating a histogram. Here, the group scan may include not only simply reading pixels, but also a step of performing a pre-scan for the group or quickly identifying a signal state with a minimum number of shots. That is, if the center ROI scan of FIG. 11 is representative sampling of a frame, the group scan of FIG. 12 may be regarded as performing spatially resolved representative sampling.

In step S1250, group-specific WER calculation and local complexity analysis are performed. Here, the group-specific WER calculation is a process of deriving a quality index by analyzing a peak width (FWHM), a peak-to-noise ratio, a possibility of multiple peaks, a baseline level, and the like of a histogram acquired in each group. In particular, FIG. 12 includes local complexity analysis, which means evaluating, by a quantitative or qualitative index, whether a corresponding group mainly includes a single reflector, whether a plurality of objects are adjacent and thus have a high possibility of overlap, or whether texture/structure is complex such that multiple reflection and scattering are significant. For example, when occurrence of a shoulder, multiple peaks, abrupt expansion of the FWHM, instability of a peak position, and the like are observed in a histogram, the complexity may be determined as high, and, conversely, when a single narrow peak is stably maintained, the complexity may be determined as low.

In step S1260, a group-specific exposure time may be set according to an analysis result of step S1250. Here, the group-specific exposure time setting is for alleviating a simultaneous problem of saturation and non-detection that is difficult to solve by global exposure. For example, in a group in which a short-distance high-reflectance object exists, an exposure time may be reduced or a storage time point Tv may be advanced in order to prevent saturation due to excessive count accumulation. Conversely, in a long-distance low-reflectance group, an exposure time may be increased or a shot count may be increased to secure peak detection reliability. In addition, from the viewpoint of the present disclosure, in addition to changing an exposure time itself, a sampling width (time bin width), a filter strength (FIR coefficient), whether to apply a multiple peak separation algorithm, and the like may also be selected for each group, and these parameters may be determined by a group-specific quality index (WER) and complexity.

In step S1270, an adaptive frame scan is performed. In this step, a main scan is performed by applying a measurement condition optimized for each group in a frame, and, if necessary, a Tv storage operation is performed for each group, and the step may be regarded as a step of finalizing a data set such that distance calculation is possible by using an obtained histogram (for example, a stored histogram and/or a frame end histogram). The adaptive frame scan may be scheduled such that a frame synchronization system is maintained while applying group-specific parameters, and, in order to reduce transmission/processing overhead between groups, a step of transmitting group results in a bundled manner or integrating group-specific processing results may also be included as post-processing.

In step S1280, ToF calculation is performed by the distance/ToF processor 830. Since signal quality differs for each group, the ToF calculation may apply a different strategy for each group. For example, for a group having a low WER, fast processing based on a single peak may be applied, and, for a group having a high WER, after performing multiple peak separation (for example, Gaussian fitting) and reliability verification, an optimum value may be selected from a plurality of ToF candidates, or, if reliability is low, remeasurement may be requested.

Finally, in step S1290, Point Cloud output is performed. At this time, the Point Cloud is configured by integrating distance values calculated for respective groups, and, if necessary, may include a group-specific quality index (for example, WER, reliability, complexity, and the like) as metadata. Through this, the host may perform not only a simple distance value but also reliability-based post-processing (for example, filtering, object separation, weight application, and the like).

FIG. 12 described above explains that, by evaluating histogram quality (WER) and local complexity in units of pixel groups, optimizing a measurement condition for each group, and then adaptively scanning a frame, saturation and overlap problems can be alleviated and reliability and a dynamic range of distance measurement can be improved even in a spatially non-uniform reflection environment.

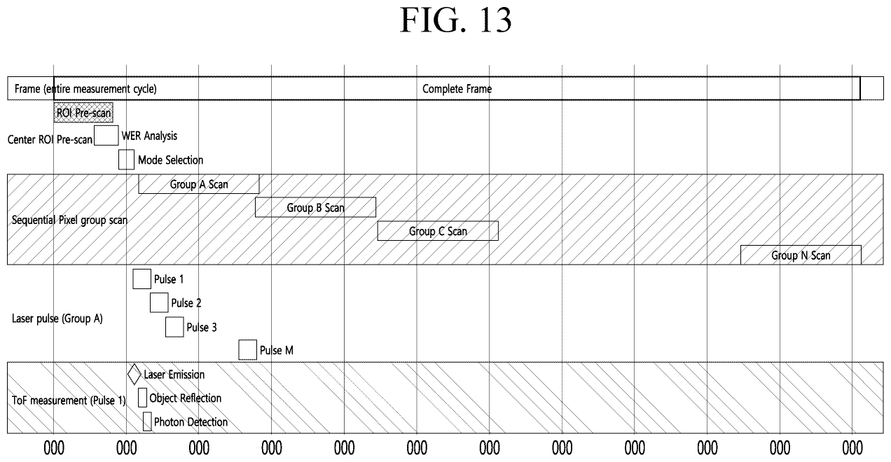

FIG. 13 is a view illustrating, in the SPAD-based LiDAR system 1 according to an embodiment of the present disclosure, a temporal structure of measurement operations performed within one frame when operating in a frame unit control mode.

In particular, FIG. 13 expresses, from a time-axis point of view, the frame unit control procedure described in FIG. 11, and indicates that a pre-scan, histogram quality analysis, control determination, and a main scan are stepwise performed within one frame.

Referring to FIG. 13, one measurement frame (Complete Frame) is configured of a plurality of time sections, and an ROI Pre-scan section may be arranged in an initial section of the frame. The ROI Pre-scan is a step for rapidly evaluating an expected histogram shape and signal quality in the corresponding frame by performing laser transmission and light reception a limited number of times for a center region or a predefined region of interest (ROI) before scanning an entire frame.

In this step, a plurality of laser pulses (Pulse 1, Pulse 2, . . . , Pulse M) are transmitted, and reflected light corresponding thereto is received so that a histogram may be accumulated and generated. The histogram acquired in the ROI Pre-scan section is transferred to a WER Analysis step, and, in this step, a histogram quality index may be calculated by analyzing a width of a histogram peak, a degree of distribution expansion, a possibility of overlap, and the like.

A quality analysis result calculated in this manner may be used as a basis for determining mode selection for determining a subsequent frame operation method. For example, when histogram quality is good, a method of applying a single measurement condition to an entire frame may be selected, and, conversely, when a possibility of overlap or saturation is high, a more elaborate control mode may be selected.

In a latter part of the frame after the pre-scan and analysis step, a main scan section may be performed. In the main scan section, distance measurement may be performed for an entire frame or a designated region according to a global measurement condition determined on a frame basis (for example, a global exposure time, a global sampling width, or a histogram storage time point policy).

At this time, an important point is that, in the structure illustrated in FIG. 13, a frame is not physically divided or a plurality of frames are not used, but the pre-scan and the main scan are temporally distinguished and performed within one frame.

In addition, at a lower portion of FIG. 13, a physical signal flow leading to laser emission, object reflection, and photon detection is also illustrated together, and this indicates that the same physical transmission/reception mechanism is repeatedly applied in each time section within the frame.

That is, the present disclosure has a structure for improving measurement quality by controlling temporal accumulation and an analysis time point of a histogram, rather than changing a hardware operation itself.

In summary, FIG. 13 is a view for explaining that, in the frame unit control mode, a pre-scan, quality analysis, control determination, and a main scan are performed in a hierarchical timing structure within one frame.

FIG. 11 is a flowchart explaining, from a functional and logical point of view, a processing procedure performed in a frame unit control mode according to an embodiment of the present disclosure. That is, FIG. 11 stepwise illustrates in what processing order an ROI pre-scan, histogram quality analysis, global control parameter determination, an entire frame scan, and distance calculation are performed within one frame.

In contrast, FIG. 13 illustrates a timing structure illustrating how each processing step described in FIG. 11 is temporally arranged within one frame. That is, FIG. 13 indicates that a pre-scan and a main scan are continuously performed within one frame, rather than in separate frames.

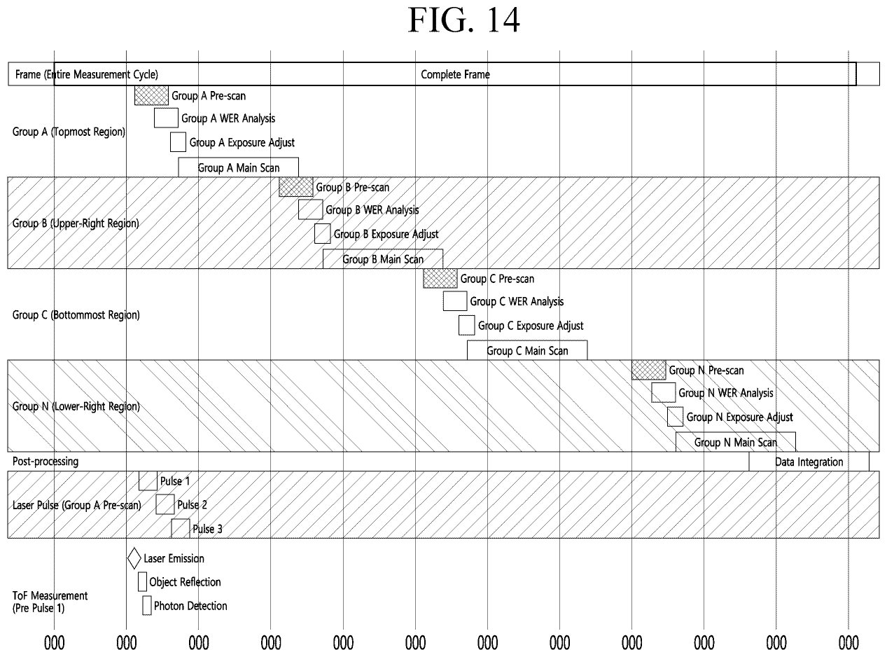

FIG. 14 is a view illustrating, in a pixel group unit control mode according to another embodiment of the present disclosure, a temporal arrangement structure of a pre-scan and a main scan operation performed for each pixel group within one frame.

In particular, FIG. 14 expresses, from a timing point of view, the pixel group unit control procedure described in FIG. 12, and indicates that, instead of applying a single control condition to an entire frame, independent pre-scan and control may be performed for each of a plurality of spatially divided pixel groups.

Referring to FIG. 14, one frame (complete frame) may be temporally divided into measurement sections for a plurality of pixel groups (Group A, Group B, Group C, . . . , Group N). In a section corresponding to each pixel group, a Group Pre-scan, a group-specific WER analysis, a group-specific exposure or measurement condition adjustment, and a Group Main Scan may be sequentially arranged.

First, a group pre-scan may be performed for a specific pixel group (for example, Group A). In this step, by performing laser transmission and light reception a limited number of times for pixels belonging to the corresponding pixel group, reflection characteristics, an ambient light level, a possibility of presence of multiple objects, and the like of the corresponding spatial region may be evaluated. A histogram generated in this process may be independently managed for each group.

Subsequently, based on a result of the group pre-scan, a group-specific WER analysis may be performed. In this analysis, a histogram peak width, a distribution shape, a possibility of overlap, and the like of the corresponding group are evaluated, and a result of the evaluation may be used in a group exposure adjust step or a measurement parameter setting step for each group.

After the group-specific measurement condition is set, a group main scan for the corresponding pixel group may be performed. In the main scan step, data for histogram accumulation and distance calculation may be acquired according to a condition set for each group.

Such a group main scan is sequentially performed within the frame, and, when the group main scan for all pixel groups is completed, frame-unit Data Integration may be performed.

In the structure illustrated in FIG. 14, although each pixel group exists within the same frame, independent pre-scan and control may be performed in different time sections. Accordingly, even when a short-distance high-reflectance object and a long-distance low-reflectance object are mixed in a scene, saturation or overlap of a specific group can be prevented from affecting measurement quality of another group. As a result, FIG. 14 is a view clearly illustrating how the present disclosure performs stable and balanced distance measurement even in a complex scene through a pre-scan structure based on spatial division+temporal division in the pixel group unit control mode.

FIG. 12 is a flowchart logically explaining a processing procedure performed in the pixel group unit control mode, and FIG. 14 is a view illustrating a timing structure illustrating how such a processing procedure is temporally arranged and performed within a frame.

In summary, FIG. 14 is a view for explaining a structure in which, in the pixel group unit control mode, an independent pre-scan, quality analysis, and a main scan are sequentially performed for each pixel group within one frame.

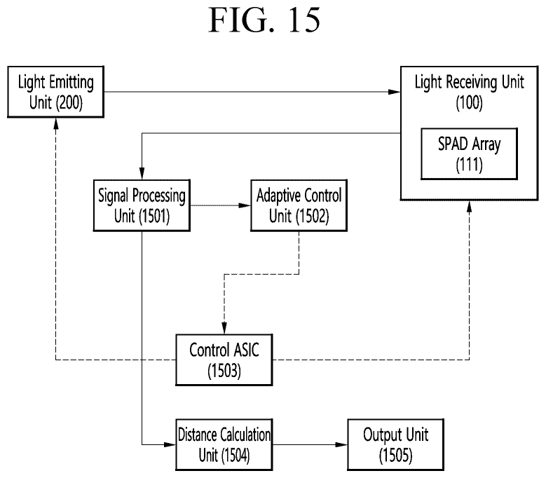

FIG. 15 is a conceptual diagram illustrating an overall distance measurement processing structure of the LiDAR system 1 according to the present disclosure.

In particular, FIG. 15 illustrates, from a system point of view, that an overall processing flow including laser transmission, photon detection, histogram-based signal processing, adaptive control, distance calculation, and result output may operate in a closed-loop structure in the SPAD-based LiDAR system 1.

As illustrated in FIG. 15, the LiDAR system 1 may include a light emitting unit 200, a light receiving unit 100, a signal processing unit 1501, an adaptive control unit 1502, a control ASIC 1503, a distance calculation unit 1504, and an output unit 1505, and the above components may interoperate to perform distance measurement and adaptive measurement control.

The light emitting unit 200 may be configured to emit a laser pulse to an external space under control of the control ASIC 1503. The laser pulse may be transmitted according to a predetermined repetition period or a controlled pulse timing, and the pulse timing and transmission condition may be dynamically adjusted according to a control decision of the adaptive control unit 1502 described later.

The laser pulse emitted from the light emitting unit 200 is irradiated onto an external object, and reflected light reflected from the object may be incident on the light receiving unit 100. The light receiving unit 100 may include a SPAD array 111 composed of a plurality of SPAD pixels, and the SPAD array 111 may detect a single photon event and generate time information corresponding to each event.

The photon events detected by the SPAD array 111 may be transferred to the signal processing unit 1501. The signal processing unit 1501 may generate a histogram using time information of the detected photon events, and may perform histogram accumulation and filtering.

In addition, the signal processing unit 1501 may extract information regarding a peak position, a peak width, and a distribution shape of the histogram, and such histogram shape information may be used for a control determination of the adaptive control unit 1502 described later.

Histogram data and peak shape information generated in the signal processing unit 1501 may be transferred to the adaptive control unit 1502. The adaptive control unit 1502 may evaluate a current measurement condition based on a histogram quality index (WER) and a peak shape analysis result, and may determine a measurement parameter.

For example, the adaptive control unit 1502 may analyze a full width at half maximum (FWHM) of a histogram peak, whether multiple peaks occur, or a degree of distortion of a histogram distribution, and may determine a measurement condition such as an exposure time, a sampling width, or pixel group control.

A control parameter determined by the adaptive control unit 1502 may be transferred to the control ASIC 1503, and the control ASIC 1503 may control operations of the light emitting unit 200 and the light receiving unit 100 based on the control parameter.

Accordingly, the LiDAR system 1 according to the present disclosure may operate in a closed-loop control structure in which a histogram analysis result generated in the signal processing unit 1501 is reflected in operations of the light emitting unit 200 and the light receiving unit 100 through the adaptive control unit 1502 and the control ASIC 1503.

Meanwhile, the histogram data generated in the signal processing unit 1501 may be transferred to the distance calculation unit 1504, and the distance calculation unit 1504 may calculate Time of Flight (ToF) based on a peak position of the histogram and convert the ToF into a distance value.

The calculated distance information may be transferred to an external device through the output unit 1505, and the output unit 1505 may generate and output Point Cloud data including the distance information and, if necessary, reflection intensity or reliability information.

The blocks illustrated in FIG. 15 represent functional blocks, and each block may be implemented by one or more hardware modules, firmware, or software configurations.

The LiDAR system according to at least one of the various embodiments of the present disclosure described above may be applied, either as it is or with slight modifications that can be easily understood by a person having ordinary skill in the art, to various industrial fields such as an Automobile, a Robot, Industrial Automation, extended Reality, Environmental monitoring, and the like.

The embodiments described above are merely examples for explaining the present disclosure, and a person having ordinary skill in the art will understand that various changes and modifications may be made within the technical spirit and scope of the present disclosure.

What is claimed is:

1. A Single Photon Avalanche Diode (SPAD)-based Light Detection And Ranging (LiDAR) apparatus, comprising:
a light emitting unit configured to transmit a laser pulse;
a sensor array configured to receive reflected light reflected from an object by the laser pulse;
a histogram generator configured to generate a histogram based on the reflected light;
a histogram quality analyzer configured to analyze a change in a shape of the histogram and determine a storage time point before histogram distortion occurs;
a storage timing controller configured to control storing of a histogram corresponding to the storage time point during histogram accumulation; and
a distance calculator configured to calculate distance information using the stored histogram.

2. The LiDAR apparatus of claim 1, wherein the histogram quality analyzer is configured to calculate an index related to a width of a histogram peak and determine the storage time point based on whether the index related to the width exceeds a reference value, and the change in the shape of the histogram is analyzed based on a change in the index calculated based on the width of the histogram peak.

3. The LiDAR apparatus of claim 2, wherein the index related to the width is a full width at half maximum (FWHM) of the histogram peak, and
wherein the histogram quality analyzer is configured to calculate a histogram quality index (WER) based on a ratio of the FWHM to a reference FWHM.

4. The LiDAR apparatus of claim 3, wherein the storage timing controller is configured to determine the storage time point as a time point at which the histogram quality index reaches or exceeds a predetermined reference value or a time point immediately before the time point.

5. The LiDAR apparatus of claim 1, wherein the histogram generator is configured to store the histogram corresponding to the storage time point in parallel while continuously performing histogram accumulation until a frame end time point.

6. The LiDAR apparatus of claim 1, wherein the histogram quality analyzer is configured to detect whether a width of a histogram peak expands due to histogram saturation and/or overlap caused by a short-distance object or a plurality of objects.

7. The LiDAR apparatus of claim 1, wherein the histogram generator or the distance calculator is configured to detect a peak after performing filtering on the stored histogram.

8. The LiDAR apparatus of claim 1, wherein the histogram generator includes a plurality of histogram memories configured to store histograms corresponding to different accumulation time points.

9. The LiDAR apparatus of claim 8, wherein the plurality of histogram memories are configured to store histograms corresponding to different storage time points within the same frame.

10. The LiDAR apparatus of claim 1, wherein determination of the storage time point is performed based on the change in the shape of the histogram irrespective of a change in an exposure time, a transmission count, a sampling width, or a filter coefficient.

11. The LiDAR apparatus of claim 1, wherein the distance calculator is configured to calculate the distance information by preferentially using the histogram stored at the storage time point rather than a histogram at a frame end time point.

12. The LiDAR apparatus of claim 1, wherein the storage time point is determined by applying a common storage time point determination criterion to one frame in a frame unit driving mode.

13. The LiDAR apparatus of claim 1, wherein the storage time point is determined for each of a plurality of pixel groups in a pixel group unit driving mode.

14. The LiDAR apparatus of claim 13, wherein the storage timing controller is configured to set different storage time points and/or different histogram storage policies for respective pixel groups.

15. The LiDAR apparatus of claim 10, wherein the sampling width is configured to be variably set according to histogram quality or an environmental condition.

16. A method of operating a SPAD-based LiDAR apparatus, the method comprising:
transmitting a laser pulse;
receiving reflected light reflected from an object by the laser pulse;
generating a histogram based on the reflected light;
analyzing a change in a shape of the histogram to determine a storage time point before histogram distortion occurs;
storing a histogram corresponding to the storage time point during histogram accumulation; and
calculating distance information using the stored histogram.
